(19) United States
(12) Patent Application Publication
(10) Pub. No.: US 2026/0309233 A1
(43) Pub. Date: Oct. 8, 2026

(54) SEAL STRUCTURE, ROTARY TABLE DEVICE, AND MACHINE TOOL

(71) Applicant: FANUC CORPORATION, Minamitsuru-gun, Yamanashi (JP)

(72) Inventor: Shingo TACHIKI, Minamitsuru-gun, Yamanashi-ken (JP)

(73) Assignee: FANUC CORPORATION, Minamitsuru-gun, Yamanashi (JP)

(21) Appl. No.: 19/480,683

(22) PCT Filed: May 11, 2023
(86) PCT No.: PCT/JP2023/017702

§ 371 Date: Oct. 31, 2025

(51) Int. Cl. F16J 15/40; F16J 15/3204; F16J 15/34; F16J 15/447

(52) U.S. Cl. CPC F16J 15/40; F16J 15/3204; F16J 15/3456; F16J 15/4472

(57) ABSTRACT

A seal structure according to the present disclosure comprises: a labyrinth seal positioned in a gap between a housing and a rotary member extending into an inner space of the housing; an oil seal which is positioned inside a space sealed by the labyrinth seal and seals the inner space; a V-ring positioned between the labyrinth seal and the oil seal; and a first air supply part which has an air supply port positioned between the V-ring and the oil seal and sends air from the air supply port to the V-ring.

### TECHNICAL FIELD

The present disclosure relates to a seal structure, a rotary table device, and a machine tool.

### BACKGROUND ART

JP 2011-033171 A discloses a seal structure (seal device) for sealing between a shaft member (roll shaft) and a housing (roll).

### SUMMARY OF THE INVENTION

There is a demand for providing an improved seal structure.

A first aspect of the present disclosure is characterized by a seal structure for sealing an internal space of a housing to which a rotating member is rotatably attached, the seal structure including: a labyrinth seal located in a gap between the rotating member and the housing, the gap communicating with the internal space; an oil seal that is located in a space sealed by the labyrinth seal in the gap, the oil seal being configured to seal the internal space; a V-ring that includes a ring main body having an annular shape and a lip protruding from the ring main body, the V-ring being located between the labyrinth seal and the oil seal in the gap; and a first air supply portion having an air supply port located between the V-ring and the oil seal, the first air supply portion being configured to send air from the air supply port to the V-ring.

A second aspect of the present disclosure is characterized by a rotary table device including the seal structure, the rotating member, and the housing, wherein the rotating member includes a table.

A third aspect of the present disclosure is characterized by a machine tool including the rotary table device.

### BRIEF DESCRIPTION OF DRAWINGS

FIG. 1 is a perspective view showing a part of a machine tool according to an embodiment;

FIG. 2 is a perspective view of a rotary table device;

FIG. 3 is a perspective view of the rotary table device;

FIG. 4 is a plan view showing a part of the rotary table device;

FIG. 5 is a cross-sectional view showing a part of the rotary table device;

FIG. 6 is a cross-sectional view showing a part of a rotary table device according to a first modification;

FIG. 7 is a cross-sectional view showing a part of a rotary table device; and

FIG. 8 is a cross-sectional view showing a part of a rotary table device.

### DETAILED DESCRIPTION OF THE INVENTION

The seal device described in JP 2011-033171 A includes an oil seal, a labyrinth seal, and the like.

There is a risk that the seal device described above cannot sufficiently protect the space to be sealed, depending on the orientation of the shaft member. For example, the shaft member may be installed along the up-down direction. In this case, foreign material such as liquid is likely to accumulate between the oil seal and the shaft member. The foreign material accumulated between the oil seal and the shaft member may enter the space sealed by the oil seal.

Air for air purge is supplied to the labyrinth seal. When air is not supplied to the labyrinth seal for some reason, foreign material or the like may pass through the labyrinth seal.

With the above-described situation in mind, an embodiment will be described below.

### Embodiment

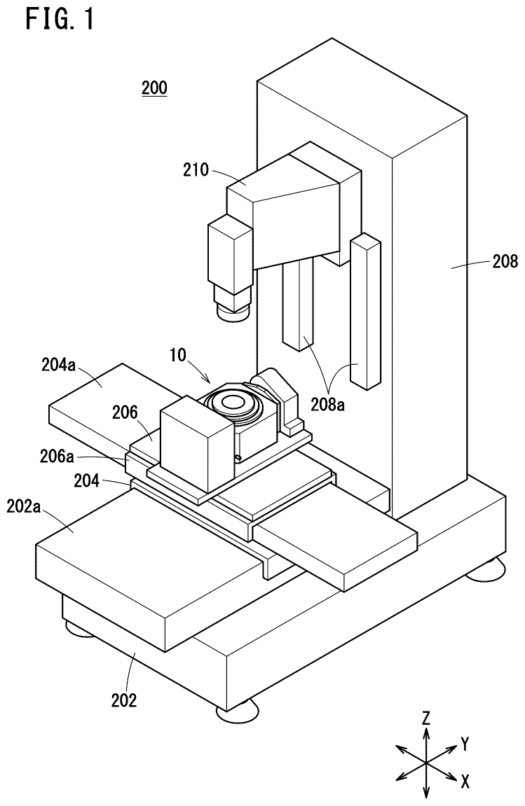

FIG. 1 is a perspective view showing a part of a machine tool 200 according to an embodiment. Each of an X-direction and a Y-direction shown in FIG. 1 is a direction parallel to a horizontal plane. The X-direction and the Y-direction are orthogonal to each other. The Z-direction is a direction perpendicular to the horizontal plane. That is, the Z-direction is the up-down direction.

The machine tool 200 is, for example, a machining center that performs machining on an object to be machined (i.e., workpiece) (not shown). The machine tool 200 includes a base (bed) 202, a saddle 204, a slide table 206, a column 208, a spindle head 210, and a rotary table device 10. The rotary table device 10 is a 2-axis rotary table device configured to rotate a table 24 (described later) about two rotation axes (L1, L2) intersecting each other.

The base 202 has a guide portion 202a. The guide portion 202a extends along the Y-direction. The saddle 204 is attached to the guide portion 202a.

The saddle 204 is guided by the guide portion 202a and is thus movable along the Y-direction. The saddle 204 has a guide portion 204a. The guide portion 204a extends along the X-direction.

The slide table 206 has a slider 206a. The slider 206a is attached to the guide portion 204a. The slider 206a (slide table 206) is guided by the guide portion 204a and is thus movable along the X-direction. When the saddle 204 moves along the Y-direction, the slide table 206 moves together with the saddle 204.

The column 208 extends from the base 202 along the Z-direction. The column 208 has a guide portion 208a. The guide portion 208a is parallel to the Z-direction. The spindle head 210 is attached to the guide portion 208a.

The spindle head 210 is guided by the guide portion 208a and is thus movable along the Z-direction. A tool (not shown) is attached to the spindle head 210.

The rotary table device 10 is installed on the slide table 206. When the slide table 206 moves along the X-direction or the Y-direction, the rotary table device 10 moves along the X-direction or the Y-direction together with the slide table 206.

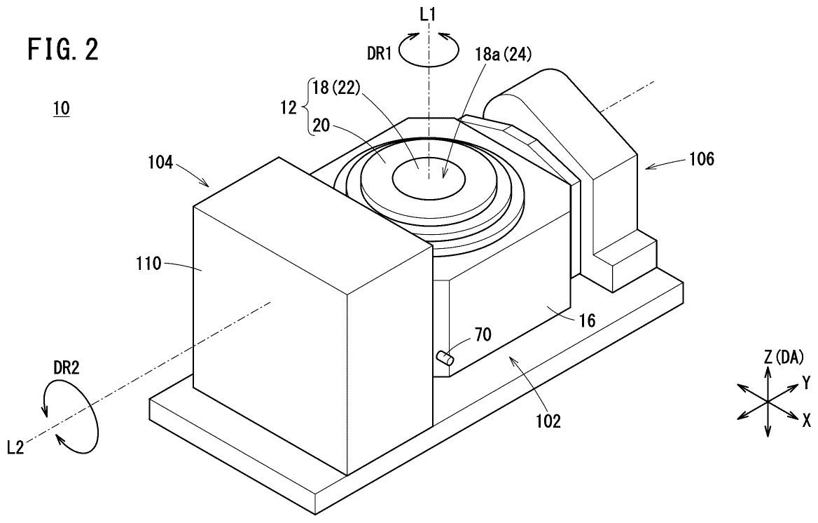

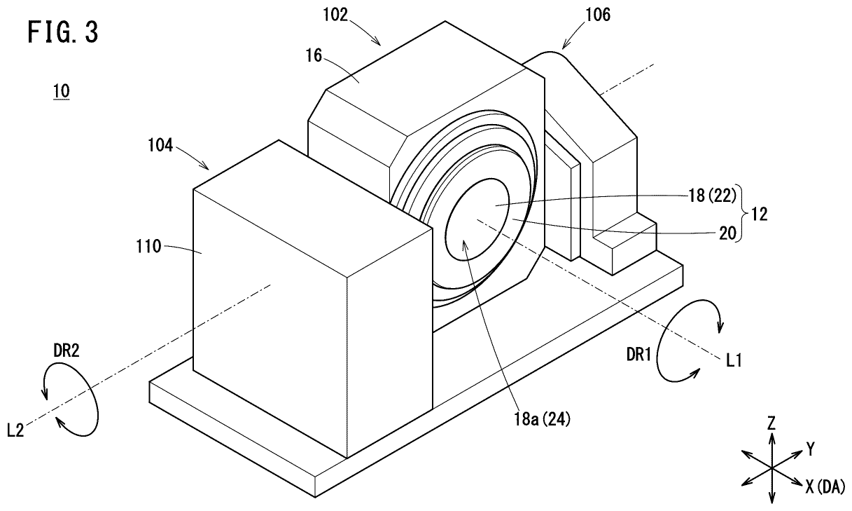

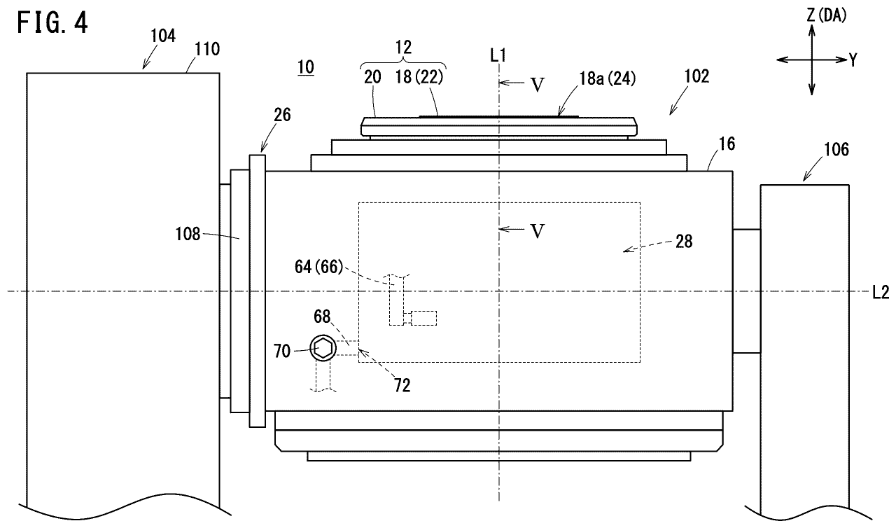

FIG. 2 is a perspective view of the rotary table device 10. FIG. 3 is a perspective view of the rotary table device 10. FIG. 4 is a plan view illustrating a part of the rotary table device 10 of FIG. 2.

The rotary table device 10 includes a first table unit 102 which is a rotation axis device, a second table unit 104 which is a tilting axis device, and a support device 106. The first table unit 102 is disposed between the second table unit 104 and the support device 106.

The first table unit 102 includes a rotating member 12 and a housing 16.

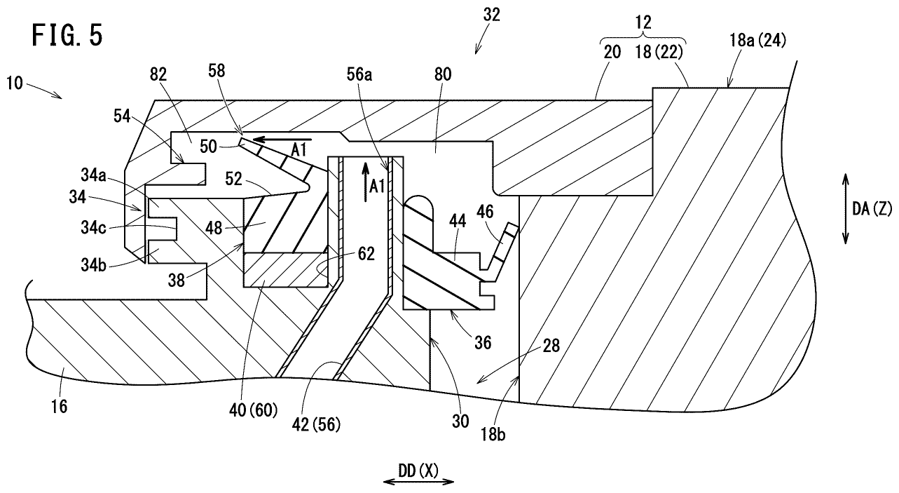

The rotating member 12 includes a shaft member 18 and a cover 20. The shaft member 18 includes a shaft 22 that is inserted into an opening 30 described later (also see FIG. 5).

The cover 20 is a member that covers the opening 30. The cover 20 is attached to the distal end portion of the shaft member 18 in the axial direction DA of the shaft member 18. That is, the cover 20 is attached to the distal end portion of the shaft member 18 in the extending direction of the rotation axis (first rotation axis) L1 of the shaft member 18.

The rotating member 12 has a table (rotary table) 24. The table 24 supports the workpiece described above. In the present embodiment, at least a part of a surface 18a of the shaft member 18 facing in the axial direction DA constitutes the table 24, but the present invention is not limited thereto. The tool attached to the spindle head 210 described above is located above the table 24. The machine tool 200 can machine a workpiece supported by the table 24 using the tool.

The rotating member 12 is rotatably mounted to the housing 16. The rotational direction DR1 of the rotating member 12 relative to the housing 16 is shown in FIG. 2. As shown in FIG. 2, the rotating member 12 is rotatable about the rotation axis L1.

The second table unit 104 is a device that tilts (rotates) the first table unit 102 about the tilting axis (second rotation axis) L2. The second table unit 104 includes a rotating member 108, a housing 110, and a drive source (such as a motor) (not shown). The rotating member 108 is rotatably supported by the housing 110. Although detailed illustration and the like are omitted in the present embodiment, the configuration of the rotating member 12 of the first table unit 102 may be used for the configuration of the rotating member 108. The configuration of the housing 16 of the first table unit 102 may be used for the configuration of the housing 110.

The rotating member 108 is connected to the housing 16 of the first table unit 102 via a coupling member 26 (FIG. 4). The drive source (not shown) provided in the second table unit 104 can rotate the rotating member 12 about the tilting axis L2. The rotational direction DR2 of the rotating member 12 which rotates about the tilting axis L2 is shown in FIGS. 2 and 3.

The support device 106 supports the first table unit 102 in a tiltable (rotatable) manner in cooperation with the second table unit 104.

The extending direction of the tilting axis L2 intersects the extending direction of the rotation axis L1. Therefore, the orientation of the rotation axis L1 (the rotating member 12) changes in accordance with the housing 16 tilting about the tilting axis L2. For example, the rotation axis L1 shown in FIG. 2 is parallel to the Z-direction. In contrast, the rotation axis L1 shown in FIG. 3 is parallel to the X-direction.

The housing 16 has an internal space 28. The internal space 28 is provided with a module, a drive source, and the like (not shown). The drive source is, for example, a motor. The drive source is connected to the shaft member 18 in order to rotate the rotating member 12.

FIG. 5 is a cross-sectional view illustrating a part of the rotary table device 10. A portion of the cross-section taken along line V-V in FIG. 4 is shown in FIG. 5.

The housing 16 further has the opening 30. The shaft member 18 is rotatably attached to the opening 30. The housing 16 may include a bearing (not shown) that rotatably supports the shaft member 18 inserted into the opening 30.

The opening 30 communicates with the internal space 28 described above. Therefore, if an appropriate seal structure is not provided in the opening 30, there is a possibility that foreign material enters the internal space 28 through the opening 30. More specifically, there is a risk that foreign material will enter the internal space 28 via a gap between the rotating member 12 and the housing 16 (see also FIG. 5). The foreign material is, for example, a liquid such as a cutting fluid used for machining the workpiece supported by the table 24, but is not limited thereto.

When the foreign material enters the internal space 28, there is a concern that the foreign material may adversely affect a module, an actuator, or the like (not illustrated) provided in the internal space 28. In view of this, in order to prevent the foreign material from entering the internal space 28, the rotary table device 10 includes a seal structure 32 described below.

The seal structure 32 includes a labyrinth seal 34, an oil seal 36, a V-ring 38, a position adjusting member 40, a first air supply portion 42, and a protruding portion 54. As shown in FIG. 5, the labyrinth seal 34, the oil seal 36, the V-ring 38, the position adjusting member 40, the first air supply portion 42 (a part of the first air supply portion 42), and the protruding portion 54 are provided in a gap between the rotating member 12 and the housing 16.

The labyrinth seal 34 is an annular seal structure. That is, although a cross section of the labyrinth seal 34 is shown in FIG. 5, the labyrinth seal 34 has an annular shape when viewed in the axial direction of the shaft member 18. The radial direction of the labyrinth seal 34 coincides with the radial direction DD of the shaft member 18. The labyrinth seal 34 surrounds the shaft member 18 when viewed in the axial direction of the shaft 22.

The labyrinth seal 34 is formed between the housing 16 and the rotating member 12. More specifically, the labyrinth seal 34 is formed between the housing 16 and the cover 20 of the rotating member 12. The labyrinth seal 34 has, for example, a labyrinthine flow path, an expansion chamber that is a relatively wide space compared to the flow path, and the like. Accordingly, the labyrinth seal 34 prevents foreign material from passing through the labyrinth seal 34, while maintaining non-contact between the housing 16 and the cover 20.

The labyrinth seal 34 includes a protrusion/recess shape that forms the labyrinthine flow path, the expansion chamber (relatively wide space), and the like described above, but the specific shape of the protrusion/recess shape is not particularly limited. For purposes of illustration, a labyrinth seal 34 having a first annular protrusion 34a, a second annular protrusion 34b, and an annular recess 34c is shown in FIG. 5. The first annular protrusion 34a, the second annular protrusion 34b, and the annular recess 34c extend along the circumferential direction of the labyrinth seal 34.

The oil seal 36 is an annular seal member. That is, although a cross section of the oil seal 36 is shown in FIG. 5, the oil seal 36 has an annular shape when viewed in the axial direction of the shaft member 18. The labyrinth seal 34 surrounds the shaft member 18 as viewed in the axial direction of the shaft 22. The radial direction of the oil seal 36 coincides with the radial direction DD of the shaft member 18.

The oil seal 36 is located inside the labyrinth seal 34 in the radial direction DD of the shaft member 18. That is, the oil seal 36 is located inside a space sealed by the labyrinth seal 34 in the gap between the rotating member 12 and the housing 16.

The oil seal 36 includes a ring main body 44 and a lip 46. The ring main body 44 is attached to the housing 16 so as to surround the shaft member 18. The lip 46 protrudes from the ring main body 44 and is in contact (close contact) with the circumferential wall 18b of the shaft member 18. Thus, the oil seal 36 seals the internal space 28. The material of the lip 46 includes, for example, a resin such as rubber.

In the following description, a space (gap space) between the oil seal 36 and the V-ring 38 in the gap between the rotating member 12 and the housing 16 is also referred to as a first gap space 80. The lip 46 protrudes so as to be inclined toward the first gap space 80 of the first gap space 80 and the internal space 28 (also see FIG. 5), but may protrude toward the internal space 28. The oil seal 36 may have a plurality of lips 46 having different protruding directions. For example, the oil seal 36 may have a lip 46 protruding toward the first gap space 80 and another lip 46 protruding toward the internal space 28.

The V-ring 38 is an annular seal member different from the oil seal 36. That is, although a cross section of the V-ring 38 is shown in FIG. 5, the V-ring 38 has an annular shape when viewed in the axial direction of the shaft member 18. The radial direction of the V-ring 38 coincides with the radial direction DD.

The V-ring 38 is located between the labyrinth seal 34 and the oil seal 36 in the radial direction DD of the shaft member 18. That is, the V-ring 38 is surrounded by the labyrinth seal 34 when viewed in the axial direction of the shaft member 18. Further, the V-ring 38 surrounds the shaft member 18 as viewed in the axial direction of the shaft member 18.

The V-ring 38 includes a ring main body 48 and a lip 50. The ring main body 48 is an annular member surrounding the oil seal 36 as viewed in the axial direction of the shaft 22. The ring main body 48 is attached to the housing 16, not to the rotating member 12.

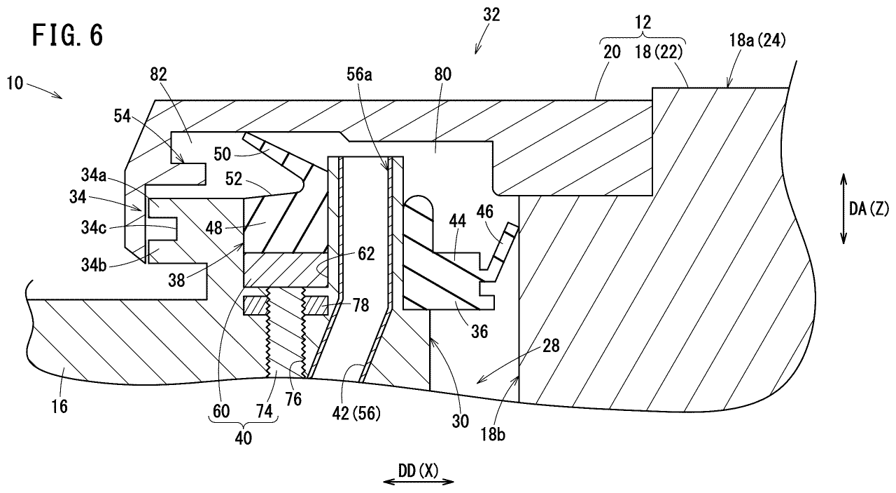

The lip 50 protrudes from the ring main body 48 toward the rotating member 12. More specifically, the lip 50 protrudes from the ring main body 48 toward the cover 20. The lip 50 can touch (closely contact) the cover 20 (see also FIG. 6). The material of the lip 50 includes, for example, a resin such as rubber.

In the following description, a space (gap space) between the labyrinth seal 34 and the V-ring 38 in the gap between the rotating member 12 and the housing 16 is also referred to as a second gap space 82. The lip 50 of the V-ring 38 protrudes so as to be inclined toward the second gap space 82 of the first gap space 80 and the second gap space 82 described above (FIG. 5). In other words, the lip 50 of the V-ring 38 protrudes outward in the radial direction (DD) of the V-ring 38.

The V-ring 38 has a recess 52 facing the second gap space 82. As shown in FIG. 5, the recess 52 is a V-shaped portion formed by the ring main body 48 and the lip 50.

The first air supply portion 42 includes a first air supply path 56. The first air supply path 56 is formed by, for example, a tube member provided in the housing 16. An air supply port 56a, which is an opening of the first air supply path 56, communicates with the first gap space 80. The first air supply portion 42 can blow out air A1 from the air supply port 56a. The air A1 is supplied from an air supply source (not shown) to the first air supply path 56. The air supply source includes, for example, a blower, a compressor, and the like. The air supply source may be provided in the rotary table device 10 (the first air supply portion 42) or may be provided outside the rotary table device 10.

The air A1 blown out from the air supply port 56a passes between the lip 50 and the cover 20 and is sent to the labyrinth seal 34. Thus, the air A1 is used as air for air purge in the labyrinth seal 34.

When the air A1 passes between the lip 50 and the cover 20, a gap 58 is formed between the lip 50 and the cover 20 (FIG. 5). In this case, the lip 50 and the cover 20 do not always have to be separated from each other over the entire circumference in the circumferential direction of the V-ring 38. That is, in the case where the gap 58 is formed, a part of the lip 50 in the circumferential direction of the V-ring 38 may remain in contact with the cover 20.

The position adjusting member 40 is a member for adjusting the position of the ring main body 48 in a direction (first direction) from the ring main body 48 toward the lip 50. In the present embodiment, the first direction coincides with the axial direction DA of the shaft 22.

The position adjusting member 40 includes, for example, a spacer (plate member) 60 disposed between the ring main body 48 and the housing 16. In this case, the housing 16 may include a groove portion 62 to which the spacer 60 can be attached. A plurality of spacers 60 having different dimensions in the first direction may be selectively attached to the groove portion 62. At least a portion of the V-ring 38 may be accommodated in the groove portion 62.

The contact pressure between the lip 50 and the cover 20 changes in accordance with the position of the ring main body 48 in the first direction. More specifically, the contact pressure between the lip 50 and the cover 20 decreases as the distance between the ring main body 48 and the cover 20 in the first direction becomes larger. Further, the contact pressure between the lip 50 and the cover 20 increases as the distance between the ring main body 48 and the cover 20 in the first direction becomes smaller.

The protruding portion 54 protrudes from the labyrinth seal 34 toward the recess 52.

The seal structure 32 further includes a second air supply portion 64, a discharge pipe 68, and an operation portion 70 (see FIG. 4 again).

The second air supply portion 64 has a second air supply path 66 that sends air to the internal space 28 of the housing 16. The second air supply portion 64 sends air to the internal space 28 to make the air pressure in the internal space 28 higher than the air pressure in the first gap space 80.

The second air supply path 66 is formed by, for example, a tube member provided in the internal space 28. The air is supplied from an air supply source (not shown) to the second air supply path 66. The air supply source includes a blower, a compressor, and the like. The air supply source may be provided in the rotary table device 10 (the second air supply portion 64) or may be provided outside the rotary table device 10. The air supply source that supplies air to the second air supply path 66 and the air supply source that supplies air A1 to the first air supply path 56 may be the same device or different devices.

The discharge pipe 68 is connected to a discharge port 72 provided in the internal space 28. The operation portion 70 includes a throttle screw, a valve, and the like connected to the discharge pipe 68, but is not limited thereto. The user can operate the operation portion 70. The amount of discharged air discharged from the internal space 28 through the discharge pipe 68 is adjusted in accordance with the operation of the operation portion 70.

The embodiment has been described as above. The seal structure 32 has the following advantageous effects.

The seal structure 32 includes the labyrinth seal 34 for sealing the second gap space 82 and the V-ring 38 for sealing the first gap space 80. Therefore, the seal structure 32 can prevent foreign material from reaching the oil seal 36. Since foreign material is prevented from reaching the oil seal 36, the foreign material is prevented from accumulating between the oil seal 36 and the shaft member 18. This prevents foreign material from entering the internal space 28.

The first air supply portion 42 can send the air A1 for air purge to the labyrinth seal 34 via the gap 58 between the cover 20 and the V-ring 38. By flowing the air A1 through the labyrinth seal 34, it is possible to satisfactorily prevent the entry of foreign material into the gap.

The first air supply portion 42 sends the air A1 to the V-ring 38 to thereby form the gap 58 between the lip 50 and the cover 20. This reduces friction between the lip 50 and the cover 20. As a result, it is possible to prevent wear and heat generation of the V-ring 38 due to friction with the cover 20.

Further, the air A1 flows from the first gap space 80 toward the second gap space 82 via the gap 58. The air A1 flowing in this manner can prevent foreign material from entering the first gap space 80 via the gap 58. That is, the first air supply portion 42 sends the air A1 to the V-ring 38 from the air supply port 56a located in the first gap space 80, so that it is possible to prevent wear and heat generation of the V-ring 38 while preventing the entry of foreign material into the first gap space 80.

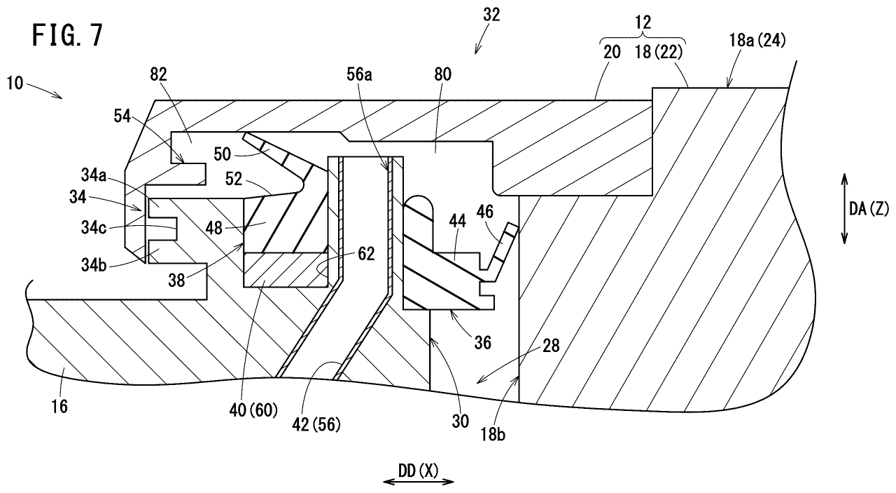

FIG. 7 is a cross-sectional view illustrating a part of the rotary table device 10. FIG. 7 shows a part of a cross section of the rotary table device 10 in a case where the air A1 is not blown out from the air supply port 56a.

For some reason, supply of the air A1 by the first air supply portion 42 may be restricted. In this case, the air A1 for air purge is not supplied to the labyrinth seal 34, but the lip 50 of the V-ring 38 is brought into close contact with the rotating member 12 (cover 20) as shown in FIG. 7. Accordingly, even when the air A1 for air purge is not sent to the labyrinth seal 34, the V-ring 38 can prevent the entry of foreign material into the first gap space 80. The situation in which supply of the air A1 by the first air supply portion 42 is restricted is, for example, a situation in which supply of electric power to the air supply source (the air blower, the compressor, or the like) is restricted due to a power failure or the like, but it is not limited thereto.

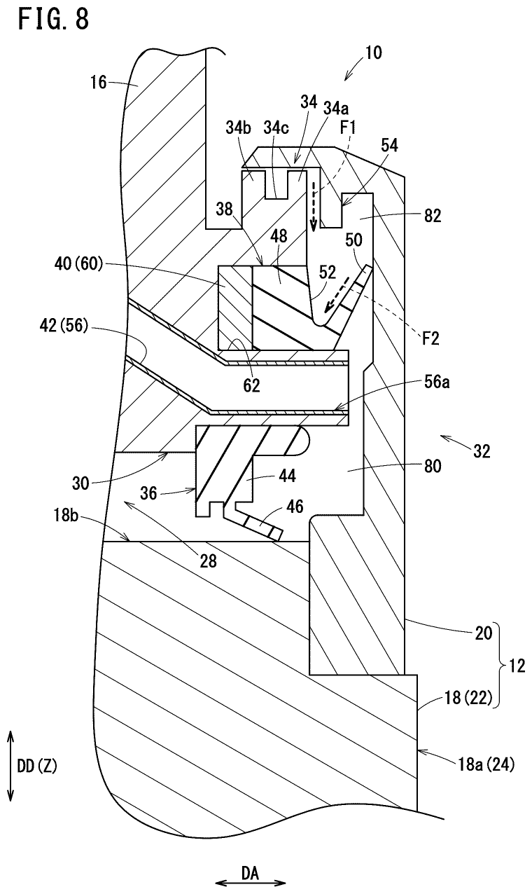

FIG. 8 is a cross-sectional view illustrating a part of the rotary table device 10. FIG. 8 shows a part of the rotary table device 10 in the state shown in FIG. 3.

In FIG. 8, the radial direction DD coincides with the Z-direction. More specifically, the direction indicated by the arrow F1 shown in FIG. 8 coincides with the direction of gravity (downward direction). In this case, even if foreign material passes through the labyrinth seal 34, the foreign material falls into the recess 52 of the V-ring 38 by the action of gravity (arrow F1 in FIG. 8). In addition, when the lip 50 constitutes a part of the recess 52, the foreign material can be dropped into the recess 52 along the surface of the lip 50 (arrow F2 in FIG. 8). This prevents foreign material from entering the space between the V-ring 38 and the oil seal 36.

Moreover, as described above, the V-shaped portion formed by the ring main body 48 and the lip 50 can be used as the recess 52. The recess 52 is a portion that is naturally present on many common V-rings. Therefore, the V-ring 38 does not need to be a custom-made component for the recess 52, and a conventional component can be used. This reduces the component procurement cost and the like.

As described above, the seal structure 32 includes the protruding portion 54 protruding from the labyrinth seal 34 toward the recess 52. The protruding portion 54 can limit a movement range (falling range) of the foreign material that has passed through the labyrinth seal 34. Accordingly, the protruding portion 54 can more reliably guide the foreign material that has passed through the labyrinth seal 34, toward the recess 52. The protruding portion 54 can also prevent the foreign material that has passed through the labyrinth seal 34 from reaching the gap 58.

The V-ring 38 is attached to the housing 16, not to the rotating member 12. In this case, the V-ring 38 does not rotate even when the rotating member 12 rotates. Therefore, even if the rotational speed of the rotating member 12 increases, the V-ring 38 is prevented from being separated from the housing 16 by centrifugal force.

The position adjusting member 40 is used to adjust the position of the ring main body 48 of the V-ring 38 in the first direction. By adjusting the position of the ring main body 48 in the first direction, the contact pressure between the lip 50 of the V-ring 38 and the cover 20 of the rotating member 12 is adjusted. The first direction is a direction from the ring main body 48 toward the lip 50. Since the contact pressure between the lip 50 and the cover 20 can be adjusted, the gap 58 can be reliably generated by the air A1 without adjusting the blower pressure of the air A1, for example.

The position adjusting member 40 includes, for example, a spacer 60. The contact pressure can be easily adjusted by changing the dimensions of the spacer 60 as necessary.

The oil seal 36 is in contact with the circumferential wall 18b of the shaft member 18 to thereby seal the gap. The V-ring 38 surrounds the oil seal 36 as viewed in the axial direction of the shaft member 18. Further, the labyrinth seal 34 surrounds the V-ring 38 as viewed in the axial direction of the shaft member 18. This makes it possible to suitably prevent foreign material from approaching the shaft member 18 along the radial direction of the shaft member 18.

The second air supply portion 64 makes the air pressure in the internal space 28 higher than the air pressure in the first gap space 80. This more reliably prevents foreign material from entering the internal space 28 through the first gap space 80.

Moreover, the amount of discharged air discharged from the internal space 28 is adjusted in accordance with the operation of the operation portion 70. Therefore, the user can easily adjust the air pressure of the internal space 28.

The embodiment may be modified as follows. In the following modifications, the description overlapping with the embodiment will be omitted. In the drawings used for explaining the following modifications, the same components as those described in the embodiment are denoted by the same reference numerals.

### (Modification 1)

FIG. 6 is a cross-sectional view showing a part of the rotary table device 10 according to a first modification.

The position adjusting member 40 may include a male screw portion 74 such as a set screw. The male screw portion 74 is screw-engaged into a female screw portion (screw hole) 76 formed in the housing 16.

The female screw portion 76 extends along the first direction from the ring main body 48 of the V-ring 38 toward the lip 50 thereof. Therefore, the male screw portion 74 can move relative to the female screw portion 76 (housing 16) along the first direction.

The ring main body 48 of the V-ring 38 is located between the female screw portion 76 (male screw portion 74) and the lip 50 of the V-ring 38. Therefore, the position of the ring main body 48 in the first direction changes in accordance with the movement of the male screw portion 74 in the first direction.

As shown in FIG. 6, a plate member 60 may be disposed between the male screw portion 74 and the V-ring 38. The plate member 60 abuts against the bottom surface of the V-ring 38 (ring main body 48).

A tightening member 78 such as a nut may be further provided in the housing 16. The tightening member 78 tightens the male screw portion 74 to thereby prevent the position of the male screw portion 74 in the first direction from being inadvertently changed.

According to the present modification, the contact pressure between the lip 50 and the cover 20 can be easily adjusted by turning the male screw portion 74.

### (Modification 2)

At least a portion of the discharged air discharged from the internal space 28 may be sent to the first gap space 80. In this case, the discharge port 72 of the internal space 28 may be connected to the first air supply path 56. This makes it possible to send the discharged air (air) from the discharge port 72 to the first air supply path 56. By using the discharged gas discharged from the internal space 28 as the air A1 to be sent to the V-ring 38, the amount of air consumed can be suppressed in the rotary table device 10 as a whole. The discharge port 72 and the first air supply path 56 are connected to each other via, for example, the above-described discharge pipe 68, but may be directly connected to each other.

The amount of discharged air sent from the internal space 28 to the space between the V-ring 38 and the oil seal 36 may be adjusted by using the operation portion 70 described above.

### (Modification 3)

The shaft member 18 may further include a case (not shown) that accommodates the shaft 22. In this case, the cover 20 may be attached to the case.

### (Modification 4)

The shaft member 18 and the cover 20 may be integrally molded.

### (Modification 5)

The recess 52 of the V-ring 38 may be a cutout portion formed in the ring main body 48 of the V-ring 38.

(modification 6)

The oil seal 36, the V-ring 38, and the labyrinth seal 34 may be arranged along the axial direction DA of the shaft member 18. In this case, the labyrinth seal 34 is formed between the housing 16 and the shaft member 18.

The V-ring 38 is disposed in a space sealed by the labyrinth seal 34 in the gap between the housing 16 and the shaft member 18. As in the embodiment, the V-ring 38 is disposed such that the recess 52 of the V-ring 38 faces the space (second gap space 82) between the labyrinth seal 34 and the V-ring 38.

The ring main body 48 of the V-ring 38 is attached to the housing 16. The lip 50 of the V-ring 38 protrudes from the ring main body 48 toward the shaft member 18 and is in contact (close contact) with the shaft member 18.

The oil seal 36 is disposed in a space sealed by the V-ring 38 in the gap between the housing 16 and the shaft member 18. The ring main body 44 of the oil seal 36 is attached to the housing 16. The lip 46 of the oil seal 36 protrudes from the ring main body 44 toward the shaft member 18 and is in contact (close contact) with the shaft member 18.

As in the embodiment, the first air supply portion 42 sends the air A1 to the space (the first gap space 80) between the V-ring 38 and the oil seal 36. The air A1 passes between the lip 50 of the V-ring 38 and the shaft member 18 and is supplied to the labyrinth seal 34.

### (Modification 7)

The seal structure 32 may be provided in the second table unit 104. In this case, for example, the seal structure 32 is provided in a gap between the rotating member 108 of the second table unit 104 and the housing 110 thereof.

### (Modification 8)

In the above embodiment, the case where the rotary table device 10 is a two-axis rotary table device has been described, but the present invention is not limited thereto. For example, the rotary table device 10 may be a single-axis rotary table device. In this case, the second table unit 104 and the support device 106 may be omitted as appropriate.

### (Combination of Plurality of Modifications)

The plurality of modifications described above may be appropriately combined together within a range in which no technical inconsistencies occur.

The following Supplementary Notes are disclosed in relation to the above embodiment.

### (Supplementary Note 1)

The seal structure (32) according to the present disclosure seals the internal space (28) of the housing (16) to which the rotating member (12) is rotatably attached. The seal structure includes: the labyrinth seal (34) located in the gap between the rotating member and the housing, the gap communicating with the internal space; the oil seal (36) that is located in the space sealed by the labyrinth seal in the gap, the oil seal being configured to seal the internal space; the V-ring (38) that includes the ring main body (48) having an annular shape and the lip (50) protruding from the ring main body, the V-ring being located between the labyrinth seal and the oil seal in the gap; and the first air supply portion (42) having the air supply port (56a) located between the V-ring and the oil seal, the first air supply portion being configured to send air (A1) from the air supply port to the V-ring.

### (Supplementary Note 2)

In the seal structure according to Supplementary Note 1, the V-ring may include the recess (52) facing the gap space (82) between the V-ring and the labyrinth seal.

### (Supplementary Note 3)

In the seal structure according to Supplementary Note 2, the lip may constitute a part of the recess.

### (Supplementary Note 4)

The seal structure according to Supplementary Note 2 or 3 may further include the protruding portion (54) protruding from the labyrinth seal toward the recess.

### (Supplementary Note 5)

In the seal structure according to any one of Supplementary Notes 1 to 4, the ring main body may be attached to the housing, and the lip may protrude toward the rotating member.

### (Supplementary Note 6)

The seal structure according to Supplementary Note 5 may further include the position adjusting member (40) configured to adjust the position of the ring main body in the first direction from the ring main body toward the lip.

### (Supplementary Note 7)

In the seal structure according to Supplementary Note 6, the position adjusting member may include the spacer (60) disposed between the ring main body and the housing.

### (Supplementary Note 8)

In the seal structure according to Supplementary Note 6 or 7, the housing may include the female screw portion (76) extending in the first direction, the position adjusting member may include the male screw portion (74) configured to be screw-engaged into the female screw portion, and the ring main body may be located between the male screw portion and the lip.

### (Supplementary Note 9)

In the seal structure according to any one of Supplementary Notes 1 to 8, the rotating member may include the shaft member (18) rotatably attached to the housing, the oil seal may be in contact with the circumferential wall of the shaft member to thereby seal the gap, the V-ring may surround the oil seal as viewed in the axial direction of the shaft member, and the labyrinth seal may surround the V-ring as viewed in the axial direction.

### (Supplementary Note 10)

The seal structure according to any one of Supplementary Notes 1 to 9 may further include the second air supply portion (64) configured to send air to the internal space to thereby make the air pressure in the internal space higher than the air pressure in the gap space (80) between the V-ring and the oil seal.

### (Supplementary Note 13)

The rotary table device (10) according to the present disclosure includes the seal structure according to any one of Supplementary Notes 1 to 10, the rotating member, and the housing, and the rotating member includes the table (24).

### (Supplementary Note 12)

The rotary table device according to Supplementary Note 11 may further include the discharge port (72) connected to the internal space, and the operation portion (70) configured to adjust the amount of discharged air discharged from the internal space via the discharge port.

### (Supplementary Note 13)

In the rotary table device according to Supplementary Note 12, the discharge port and the air supply port may be connected to each other, and at least a part of the discharged air discharged from the internal space may be supplied to the gap space between the V-ring and the oil seal.

### (Supplementary Note 14)

In the rotary table device according to any one of Supplementary Notes 11 to 13, the rotary table device may be a two-axis rotary table device.

### (Supplementary Note 15)

The machine tool (200) according to the present disclosure includes the rotary table device according to any one of Supplementary Notes 11 to 14.

Although the present disclosure has been described in detail, the present disclosure is not necessarily limited to each of the embodiment and modifications. These embodiments may be subjected to various additions, substitutions, modifications, partial deletions, and the like, within a range that does not deviate from the essence and gist of the present disclosure, or the spirit of the disclosure as derived from the contents described in the claims and their equivalents. Further, these embodiments can also be implemented together in combination. For example, in the above-described embodiments, the order of each of the operations and the order of each of the processes are merely shown as examples, and the present invention is not necessarily limited to these examples. Further, the same applies in the case that numerical values or mathematical expressions are used in the description of the aforementioned embodiments.

### REFERENCE SIGNS LIST

10: rotary table device
12: rotating member
16: housing
18: shaft member
24: table
28: internal space
32: seal structure
34: labyrinth seal
36: oil seal
38: V-ring
40: position adjusting member
42: first air supply portion
48: ring main body
50: lip
52: recess
54: protruding portion
56: first air supply path
56a: air supply port
60: spacer
64: second air supply portion
70: operation portion
72: discharge port
74: male screw portion
76: female screw portion
80: gap space (first gap space)
82: gap space (second gap space)
200: machine tool
A1: air

1. A seal structure for sealing an internal space of a housing to which a rotating member is rotatably attached, the seal structure comprising:
a labyrinth seal located in a gap between the rotating member and the housing, the gap communicating with the internal space;
an oil seal that is located in a space sealed by the labyrinth seal in the gap, the oil seal being configured to seal the internal space;
a V-ring that comprises a ring main body having an annular shape and a lip protruding from the ring main body, the V-ring being located between the labyrinth seal and the oil seal in the gap; and
a first air supply portion having an air supply port located between the V-ring and the oil seal, the first air supply portion being configured to send air from the air supply port to the V-ring.

2. The seal structure according to claim 1, wherein
the V-ring includes a recess that faces a gap space between the V-ring and the labyrinth seal.

3. The seal structure according to claim 2, wherein
the lip constitutes a part of the recess.

4. The seal structure according to claim 2, further comprising a protruding portion protruding from the labyrinth seal toward the recess.

5. The seal structure according to claim 1, wherein
the ring main body is attached to the housing, and the lip protrudes toward the rotating member.

6. The seal structure according to claim 5, further comprising a position adjusting member configured to adjust a position of the ring main body in a first direction from the ring main body toward the lip.

7. The seal structure according to claim 6, wherein
the position adjusting member includes a spacer disposed between the ring main body and the housing.

8. The seal structure according to claim 6, wherein
the housing includes a female screw portion extending in the first direction,
the position adjusting member includes a male screw portion configured to be screw-engaged into the female screw portion, and
the ring main body is located between the male screw portion and the lip.

9. The seal structure according to claim 1, wherein
the rotating member includes a shaft member rotatably attached to the housing,
the oil seal is in contact with a circumferential wall of the shaft member to thereby seal the gap,
the V-ring surrounds the oil seal as viewed in an axial direction of the shaft member, and
the labyrinth seal surrounds the V-ring as viewed in the axial direction.

10. The seal structure according to claim 1, further comprising a second air supply portion configured to send air to the internal space to thereby make an air pressure in the internal space higher than an air pressure in a gap space between the V-ring and the oil seal.

11. A rotary table device comprising:
the seal structure according to claim 1;
the rotating member; and
the housing,
wherein the rotating member includes a table.

12. The rotary table device according to claim 11, further comprising:
a discharge port connected to the internal space; and
an operation portion configured to adjust an amount of discharged air discharged from the internal space through the discharge port.

13. The rotary table device according to claim 12, wherein
the discharge port and the air supply port are connected to each other, and at least a part of the discharged air discharged from the internal space is supplied to a gap space between the V-ring and the oil seal.

14. The rotary table device according to claim 11, wherein
the rotary table device is a two-axis rotary table device.

15. A machine tool comprising the rotary table device according to claim 11.
